(19) United States
(12) Patent Application Publication
(10) Pub. No.: US 2009/0181214 A1
(43) Pub. Date: Jul. 16, 2009

(54) FASTENER STRUCTURE WITH A FINE PATTERN ON A SURFACE THEREOF

(76) Inventor: SHIH-SHENG YANG, Wu Ku Hsiang (TW)

Correspondence Address: LEONG C LEI, PMB # 1008, 1867 YGNACIO VALLEY ROAD, WALNUT CREEK, CA, 94598, US

(21) Appl. No.: 12/407,798

(22) Filed: Mar. 20, 2009

Related U.S. Application Data
(63) Continuation-in-part of application No. 11/432,612, filed on May 12, 2006.

(51) Int. Cl. B32B 3/30

(52) U.S. Cl. 428/156

(57) ABSTRACT

A fastener structure with a fine pattern on a surface thereof, wherein a mold core is formed with a mold cavity having a fastener member shape, and a layer of adhesive paper is adhered to an area of the mold cavity desired to be fashioned with a decorative design, then laser engraving machining technology is used to engrave out a specific pattern on the mold cavity. Adhesive paper out of the pattern is removed, and mold texturing (electro-discharge machining) is implemented. Finally, the residual adhesive paper is torn away to reveal a non-textured fine pattern in the mold cavity, and plastic ejection molding is implemented to manufacture a fastener member having a fine pattern, thereby increasing aesthetic appeal of the fastener member.

### CROSS-REFERENCE TO RELATED APPLICATION

This is a continuation-in-part of the co-pending patent application Ser. No. 11/432,612, filed May 12, 2006.

### TECHNICAL FIELD OF THE INVENTION

The present invention is related to a fastener structure with a fine pattern on a surface thereof, and in particular to one which is manufactured by incorporating texturing (electro-discharge machining) to the surface of a molded cavity to produce a specific pattern, thereby enabling a surface of an injection molded fastener member to have a decorative design with increased aesthetic appeal.

### DESCRIPTION OF THE PRIOR ART

Fastener members have extensive application in articles of daily use, such as clothing, backpacks, and so on, and the forms and varieties used in the current market are innumerable. Moreover, because of the increase in the quality of life of people, there has been a corresponding increase in the demand for quality in goods. However, regarding the design aspect of prior art fastener members, there is no area for significant variation in the production of external form, color and texture of decorative designs.

Hence, in light of the aforementioned, the inventor of the present invention, having accumulated years of design development experience in related arts, attentively and circumspectly carried out extensive study and exploration to ultimately provide a method to more positively embellish the fastener members and increase their aesthetic appeal so as to improve the distinguishing characteristics of the fastener members, thereby increasing added value to relevant products that use the fastener members for the use by consumers and the general public.

### SUMMARY OF THE INVENTION

A primary objective of the present invention is to provide a fastener structure with a fine pattern on a surface thereof, which uses laser engraving machining technology in association with an adhesive layer combined with mold texturing to produce a specific fine pattern on a surface of an injection molded fastener member, thereby increasing aesthetic appeal thereof.

Another objective of the present invention is to provide a fastener structure with a fine pattern on a surface thereof for forming a fine pattern on a surface of a fastener member with enhanced distinguishing characteristics, thereby increasing added value of the product using such fastener member.

In order to achieve the aforementioned objectives, steps to manufacture the fastener structure with a fine pattern on a surface thereof are as follows:

(a) Fabricating a mold core: A fashioned mold core is manufactured.

(b) Adding adhesive paper to the mold cavity: A layer of adhesive paper is adhered to the desired machining portion in a mold cavity.

(c) Laser cutting a specific pattern: Laser engraving machining technology is used to engrave out a specific pattern of any shape on the adhesive paper on the surface of the mold cavity.

(d) Removing unwanted rim of the pattern: Surplus adhesive paper of the pattern is removed, with the pattern portion retained.

(e) Implementing mold texturing: A decorative design is etched out on the portion out of the pattern to form a matt surface.

(f) Removing residual adhesive paper: The residual adhesive paper within the mold cavity is torn away.

(g) Completing a mold core with the surface having a decorative design: A non-textured bright surface in the mold cavity with fine patterned decorative design is revealed.

(h) Implementing plastic ejection molding: An injection molding machine using the finished mold is employed to manufacture a fastener member, thereby obtaining the fastener member with increased aesthetic appeal.

To enable a further understanding of said objectives and the technological methods of the invention herein, brief description of the drawings is provided below followed by detailed description of the preferred embodiments.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows a block flow diagram depicting a manufacturing method according to the present invention.

FIG. 2 shows a schematic view of processing step (a) according to the present invention.

FIG. 3 shows a schematic view of processing steps (b) and (c) according to the present invention.

FIG. 4 shows a schematic view of processing steps (d) and (e) according to the present invention.

FIG. 5 shows a schematic view of processing steps (f), (g) and (h) according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

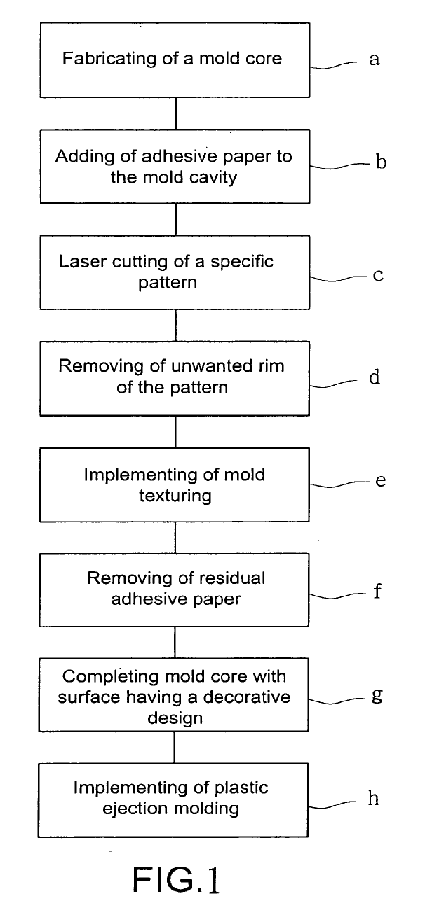

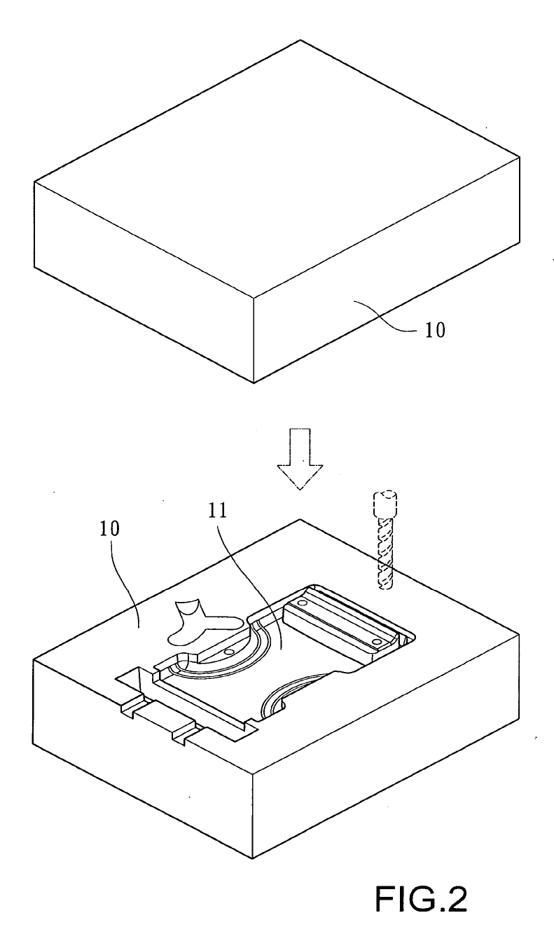

Referring to FIG. 1, which shows a block flow diagram of a manufacturing method of the fastener member according to the present invention, and in conjunction with FIGS. 2, 3, 4 and 5, particular steps involved to the manufacturing method of the present invention are as described hereinafter:

(a) Fabricating a mold core: A mold core 10 is first manufactured, and a machine tool is used to implement milling to produce a mold cavity 11 having the contour of a fastener member and a smooth surface (see FIG. 2).

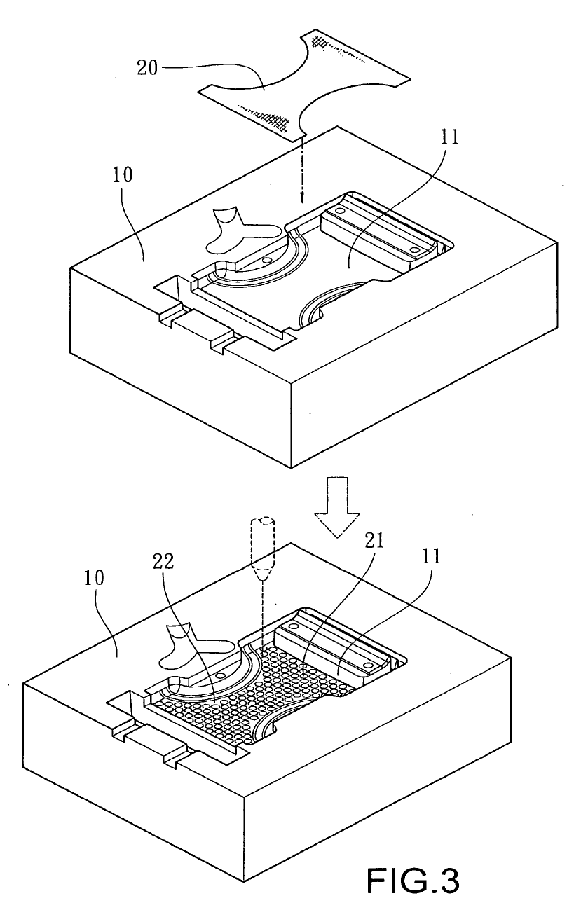

(b) Adding adhesive paper to the mold cavity: One layer of an adhesive paper 20 is adhered on the smooth surface of the mold cavity 11 to make apparent the desired region prepared for further processing of a cambered surface with fine heights and drops or plane surface (see FIG. 3).

(c) Laser cutting a specific pattern: A specific pattern 21 (which can be of any geometric form, including circular, triangular, quadrangular and polygonal form) is engraved out of the adhesive paper 20 on the desired region prepared for further processing of the surface of the mold cavity 11 using laser engraving machining technology, and machining is carried out by setting depth sectioning of the laser machining head according to the working face of different heights.

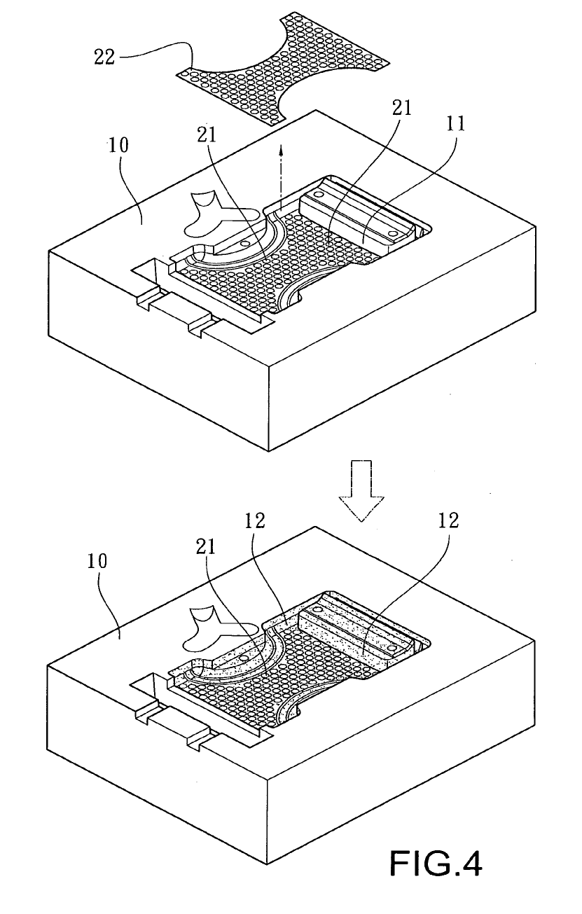

(d) Removing unwanted rim of the pattern: Adhesive paper from rim 22 portion out of the pattern 21 is manually removed, retaining the pattern 21 portion within the mold cavity 11 (see FIG. 4).

(e) Implementing mold texturing: Mold texturing (electro-machining) is implemented in the mold cavity 11 whereby a decorative design is etched out on the extra rim portion of the pattern 21 forming a matt surface 12, wherein etching depth is approximately between 0.2 and 0.5 mm (see FIG. 4).

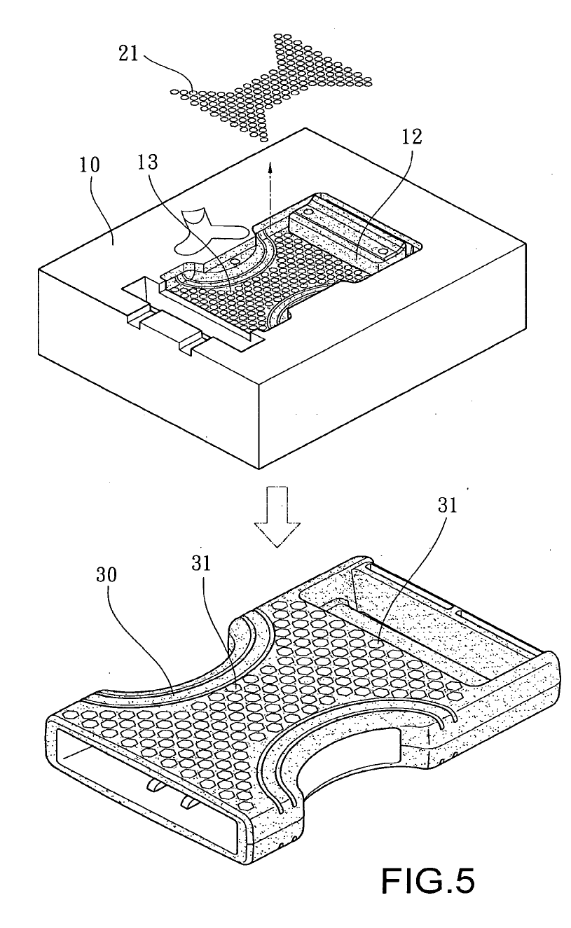

(f) Removing residual adhesive paper: The adhesive paper of the pattern 21 portion previously retained in the mold cavity 11 is torn away (see FIG. 5).

(g) Completing a mold core with the surface having a decorative design: A decorative design 13 provided with a bright (mirror) surface within the mold cavity 11 is revealed after tearing away the residual adhesive paper within the mold cavity 11 (see FIG. 5), the design 13 having a slightly recessed surface which has a depth between 0.2 mm and 0.5 mm.

(h) Implementing plastic ejection molding: An ejection molding machine using the fabricated mold core 10 is employed to produce a fastener member 30 having a surface with a fine pattern 31.

Accordingly, a fastener member having aesthetic appeal can be created employing the aforementioned method, which increases the distinguishing characteristics of the fastener member, thereby increasing added value to relevant products that use the fastener members. Under the same principle, when the mold core forms a recess for a molded button or zipper accessory tab, application of the aforementioned manufacturing process can be similarly used to manufacture products having a surface with the fine pattern 31.

In the above-mentioned step (b) for adding adhesive paper to the mold cavity, only the cambered surface with fine heights and drops or plane surface are appropriate region for being prepared for further processing where the adhesive paper 20 is affixed (see FIG. 3). Similarly, in the above-mentioned step (c) for laser cutting a specific pattern at the cambered surface with different heights, it is necessary to use the laser machining head to carry out machining at a certain height and then adjust the laser machining head to a higher or lower position to carry out machining at different heights to cut a specific pattern.

In conclusion, according to the aforementioned disclosures, the present invention clearly achieves effectiveness of anticipated advancement, and provides the method for forming a fine pattern on a surface of a fastener member. Moreover, practicability and advancement of the present invention clearly comply with essential elements as required for a new patent application. Accordingly, a new patent application is proposed herein.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A fastener structure comprising:
a fine pattern provided on plane surface and cambered surface, the fine pattern having a smooth (mirror) outer surface, the pattern having a recessed plane surface, extra rim of the pattern forming a matt surface, said fastener structure being manufactured by a method comprising steps of:
(a) fabricating a mold core: a mold core having a shape of said fastener structure and having a mold cavity, said mold cavity having a shape of said fastener structure and having a smooth surface;
(b) adding adhesive paper to the mold cavity: a layer of adhesive paper being adhered to predetermined machining portion of the mold cavity to make apparent the predetermined machining portion prepared for further processing of a cambered surface with fine heights and drops or plane surface;
(c) laser cutting a specific pattern: laser engraving machining technology being used to engrave out a specific pattern on the adhesive paper on the predetermined machining portion prepared for further processing;
(d) removing unwanted rim of the pattern: surplus adhesive paper of the pattern being removed, with the pattern portion retained;
(e) implementing mold texturing: a decorative design being etched out on extra portion out of the pattern to form a matt surface;
(f) removing residual adhesive paper: the residual adhesive paper within the mold cavity being torn away;
(g) completing a mold core with the surface having a decorative design: a non-textured bright surface in the mold cavity with fine patterned decorative design being revealed, the pattern having recessed surface;
(h) implementing plastic ejection molding: an injection molding machine using the finished mold is employed to manufacture a fastener member having a surface of fine pattern.

2. The fastener structure as claimed in claim 1, wherein the recessed plane surface of the pattern has a depth between 0.2 mm and 0.5 mm.
